(19) United States
(12) Patent Application Publication
(10) Pub. No.: US 2016/0283885 A1
(43) Pub. Date: Sep. 29, 2016

(54) METHOD FOR EVALUATING RELATIVE PERFORMANCE FOR A SPECIFIC PERFORMANCE INDICATOR AT A POINT IN TIME

(71) Applicant: Brian David Tramontini, Sudbury (CA)

(72) Inventor: Brian David Tramontini, Sudbury (CA)

(21) Appl. No.: 14/669,031

(22) Filed: Mar. 26, 2015

(51) Int. Cl. G06Q 10/06

(52) U.S. Cl. CPC G06Q 10/06398

(57) ABSTRACT

A method for Stratim™ Performance Index Normalization is disclosed that comprises a set of input parameters, decision criteria and formulae. A normalized Performance Index represents relative performance for a specific measure (or performance indicator) at a point in time. The Performance Index is calculated based on a plurality of input parameters. This is implemented in the Stratim™ Performance Index Normalization SPIN( ) function using Excel DNA™ technology. The parameters may be simple, scalar inputs or they may be calculated individually in a variety of ways. For a given measure at a specific point in time, a Performance Index is calculated using 5 parameters: Actual, Baseline, Target, Model and Function. The performance index represents the distance of the Actual parameter relative to the Baseline and Target parameters. The Model parameter specifies the decision as to how the Actual, Baseline and Target parameters are to be used by specifying one of three calculation models: Increasing; Decreasing; Corridor. The Function parameter determines whether standardized (limited to between 0 and 1) or raw (non-standardized) performance is returned as the result of the SPIN( ) function.

### TECHNICAL FIELD

The invention relates generally to computer-implemented methods and apparatuses, including computer program products, for organizational performance management, and more particularly, to the use of relative performance allowing groups of measures with different characteristics to be aggregated and desegregated, simply and dynamically, over time.

### BACKGROUND OF THE INVENTION

“Organizational performance comprises the actual output or results of an organization as measured against its intended outputs (or goals and objectives).

Specialists in many fields are concerned with organizational performance including strategic planners, operations, finance, legal, and organizational development.

In recent years, many organizations have attempted to manage organizational performance using the balanced scorecard methodology where performance is tracked and measured in multiple dimensions such as:
financial performance (e.g. shareholder return)
customer service
social responsibility (e.g. corporate citizenship, community outreach)
employee stewardship
   (Definition from Wikipedia)”

In managing organizational performance, it is often useful to compare performance between areas of an organization or across various organizations. These comparisons are useful in determining what constitutes acceptable or poor performance. In many cases it is useful to aggregate several indicators into groups in order to get a sense of overall performance in some organizational, physical or conceptual area or topic.

Organizational performance is tracked using well-defined performance measures or performance indicators. Each of these may have different scales upon which they are measured. In some cases, increasing is “good”; in others decreasing is “good”; sometime performance within a “reasonable” range determines how well you are doing. Performance index normalization allows each measure to stand on it's own—but also allows them to be integrated to dynamically form composite indices with multiple dimensions. The dynamic nature of this model complements the dynamic analysis tools to provide a truly flexible performance management mechanism.

It would be useful to have a method that facilitates these processes, calculations and analyses. This would simplify and enable these to enhance effective organizational performance management.

### SUMMARY OF THE INVENTION

A computer-implemented method and apparatus is disclosed that comprises a set of input parameters, decision criteria and formulae. This method is called Stratim™ Performance Index Normalization (SPIN). This produces a normalized Performance Index or SPIN value.

A normalized Performance Index represents relative performance for a specific measure (or performance indicator) at a point in time. The Performance Index is calculated based on a plurality of input parameters. The parameters may be simple, scalar inputs or they may be calculated individually in a variety of ways.

For a given measure at a specific point in time, a Performance Index is calculated using 5 parameters: Actual, Baseline, Target, Model, and Function. The Performance Index represents the distance of the Actual parameter relative to the Baseline and Target parameters. The Model parameter specifies the decision as to how the Actual, Baseline and Target parameters are to be used by specifying one of three calculation models: Increasing; Decreasing; Corridor. The Function parameter specifies whether the performance index returned by the SPIN( ) function is standardized (to between 0 and 1) or raw (not standardized).

The use of relative performance allows groups of measures with different characteristics to be aggregated and desegregated, simply and dynamically, over time. By different characteristics we mean:
Different units of measurement (Percentages; Dollars; Counts; Rates; Metres; Kilograms; etc.)
Different orders of magnitude (fractions; tens; millions; etc.)
How performance improvement is assessed (increasing is good; decreasing is good; proximity to a midpoint is good.
Stratim™ Performance Index Normalization is useful wherever: groups of measures are tracked as components of a broader performance index or individual items or events, described by the measure need to be analyzed and compared at different levels of aggregation. For example, safety index for a hospital comprised of several components such as: Infection Rates; Patient Falls; Hand Hygiene compliance rate. Individual employee performance relative to some individual measure aggregated to departmental and organizational levels.

The performance index can be used for a variety of graphical or textual representations and analyses. This is useful in applications where tracking individual and organizational performance, risk or quality is important.

These and other features and advantages of the invention will be more fully understood from the following detailed description of the invention taken together with the accompanying drawings.

### BRIEF DESCRIPTION OF THE DRAWINGS

In the drawings:

FIG. 1 is a diagram showing how the Performance Index is calculated;

FIG. 2 is a graph which charts the Food Temperature Compliance Rate in an institution over time;

FIG. 3 is a graph which charts the Falls Rate in an institution over time; and

FIG. 4 is a graph which charts the Budget Variance in an institution over time.

### DETAILED DESCRIPTION OF THE INVENTION

Strategic Management provides a comprehensive, integrated framework to support strategy and organizational performance. This invention involves the calculation and determination of a Performance Index using input parameters, which are then used to monitor organizational performance, quality and risk.

For a given measure at a specific point in time, a Performance Index is calculated using 5 parameters: Actual, Baseline, Target, Model, and Function. The Performance Index represents the distance of the Actual parameter relative to the Baseline and Target parameters. The Model parameter specifies the decision as to how the Actual, Baseline and Target parameters are to be used by specifying one of three calculation models: Increasing; Decreasing; Corridor. The Function parameter specifies whether the performance index returned by the SPIN( ) function is standardized (to between 0 and 1) or raw (not standardized).

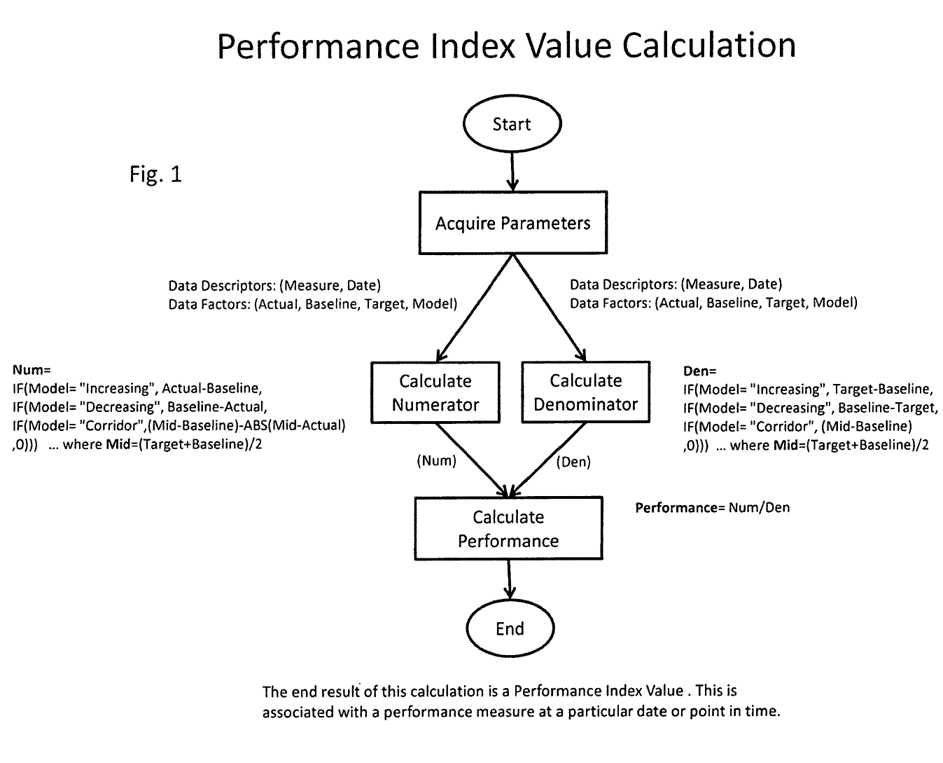

Referring to FIG. 1, the Performance Index is calculated as follows;

STEP 1: Acquire Parameters—Five parameters are used: Actual, Baseline, Target, Model and Function.

Actual means the actual, real performance value for a performance measure at a point in time.

Baseline is a performance value parameter for a performance measure used as the basis for performance improvement. Baseline is the value which the measure is intended to improve from over time. If Actual performance is near the Baseline, this is viewed as poor performance as little or no improvement has been made towards performance objectives.

Target is a performance value parameter for a performance measure used as the basis for performance improvement. Target is the performance value which the measure is intended to improve towards over time. If Actual performance is near the Target, this is viewed as good performance as performance objectives have been achieved.

Model defines how the Actual, Baseline and Target parameters are to be used by specifying one of three calculation models: Increasing; Decreasing; Corridor. If the Model is “Increasing” then the objective is to have increasing actual values over time. If the Model is “Decreasing” then the objective is to have decreasing actual values over time. If the Model is “Corridor” then the objective is to have relatively consistent actual values over time.

Function determines if performance values are returned by the SPIN( ) function are standardized or raw (not standardized). Standardizing performance limits returned values to a range between 0 and 1. This is used to remove extreme performance that might otherwise overemphasize a performance index in aggregate performance indices where weighted averages are used. Raw performance does not standardize the performance to between 0 and 1. Negative values are allowed as are values greater than 1. Standardized performance is recommended as the default where aggregation is used. With standardized performance 1 means ‘the target was achieved’; 0 means ‘the baseline was reached’. With standardized performance it is immaterial if performance far exceeds the target or baseline.

STEP 2: Calculate Numerator—The numerator is calculated as follows:

If the Model used is “Increasing”, then the numerator is the Actual value minus the Baseline value.

If the Model used is “Decreasing”, then the numerator is the Baseline value minus the Actual value.

If the Model used is “Corridor”, then the numerator is (Mid value minus Baseline value) minus the absolute value of (Mid value minus Actual value). The Mid value is the sum of the Target value and the Baseline value, divided by 2.

In Microsoft Excel™, the formulae is written as follows:

Num=IF(Model=“Increasing”,Actual-Baseline,IF(Model=“Decreasing”,Baseline−Actual,IF(Model=“Corridor”,(Mid−Baseline)−ABS(Mid−Actual),0))) . . . where Mid=(Target+Baseline)/2

STEP 3: Calculate Denominator—The denominator is calculated using the following formulae

If the Model used is “Increasing”, then the denominator is the Target value minus the Baseline value.

If the Model used is “Decreasing”, then the denominator is the Baseline value minus the Target value.

If the Model used is “Corridor”, then the denominator is the Mid value minus Baseline value. The Mid value is the sum of the Target value and the Baseline value, divided by 2.

In Microsoft Excel™, the formulae is written as follows:

Den=IF(Model=“Increasing”,Target-Baseline,IF(Model=“Decreasing”,Baseline−Target,IF(Model=“Corridor”,(Mid−Baseline),0))) . . . where Mid=(Target+Baseline)/2

STEP 4: Calculate and return Performance Index—The intermediate result of this calculation is a Performance Index value. The Performance Index is calculated by dividing the numerator by the denominator. This is associated with a performance measure at a particular date or point in time. A Function parameter=1 means that a raw (non-standardized) performance value will be returned by the SPIN( ) function. A Function parameter=0 means that a standardized performance value will be returned by the SPIN( ) function.

### Calculations:

Performance=Num/Den

If Function=1 (Raw Performance is chosen),

SPIN=Performance

If Function=0 (Standardized Performance is chosen),

SPIN=IF(Performance>1,1,IF(Performance<0,0,Performance))

Where the Target and Actual intersect, the Performance Index is 1.0 and represents 100% success or achievement.

Where the Baseline and the Actual intersect, the Performance Index is 0.

STEP 5: Optional calculations—In the case where performance index normalization is used to calculation aggregate performance indices, the following calculations are made:

To calculate the weighted SPIN value for a specific measure at a point in time:

SPINWt=Wt*SPIN

where Wt is a weight value applied to the SPIN function.

To calculate the weighted SPIN value as a component of an aggregate performance index for a specific measure at a point in time:

SPIN Weighted=SPINWt/SUM(Wt)

where SUM(Wt) represents the aggregate weight of all SPIN values in the aggregate performance index.

The Average of all SPIN Weighted values for a set of performance measures at a point in time generates the Aggregate Performance Index.

Note: The discussion of weighting illustrates the usefulness of the SPIN value and how it is applied but neither the idea or calculation of weighting in general is unique. What IS unique is that using SPIN( ) allows for aggregation and weighting of different performance measures.

### Table 1: Increasing Model: Improving Performance

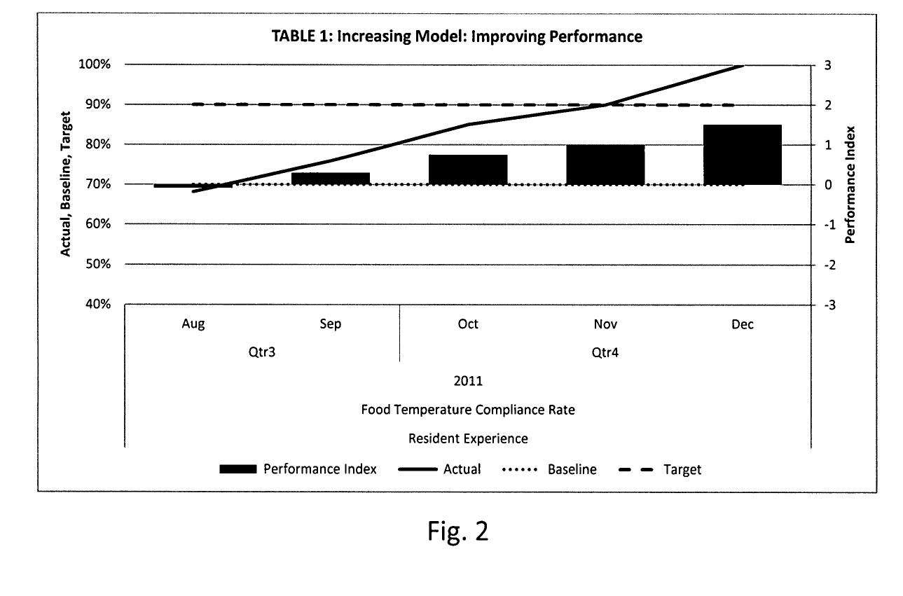

Referring to FIG. 2, Table 1: Increasing Model: Improving Performance, there is shown a graph which charts the Food Temperature Compliance Rate in an institution over time from August to December, 2011.

The left axis represents the Actual, Baseline and Target values.

The Food Temperature Compliance Rate is an increasing model, which means the objective is for the Actual number to go up. In other words, the objective is for the food to be served at the correct temperature all of the time, measured by an increasing compliance rate with policy.

The Baseline in an increasing model is below the Target value.

In this example, the measure started below the Baseline value (poor) and increased until it is now above the Target value (good).

The right axis represents the Performance Index values, with the Performance Index represented by the bars. A Performance Index of 0 or less means that performance is poor. A Performance Index of 1 or more means that performance is good.

At the start of this example, the Performance Index is below 0, which corresponds with the Actual value being worse than the Baseline value.

At the end of this example, the Performance Index is above 1. This corresponds with the Actual value being better than the Target value.

TABLE 1

| | | | | Performance |
|---|---|---|---|---|
| | Actual | Baseline | Target | Index |
| Resident Experience | 0.84 | 0.70 | 0.90 | 0.69 |
| Food Temperature | 0.84 | 0.70 | 0.90 | 0.69 |
| Compliance Rate | | | | |
| 2011 | | | | |
| Qtr3 | | | | |
| August | 0.68 | 0.70 | 0.90 | −0.09 |
| September | 0.76 | 0.70 | 0.90 | 0.29 |
| Qtr4 | | | | |
| October | 0.85 | 0.70 | 0.90 | 0.75 |
| November | 0.90 | 0.70 | 0.90 | 1.00 |
| December | 1.00 | 0.70 | 0.90 | 1.50 |

### Table 2: Decreasing Model: Improving Performance

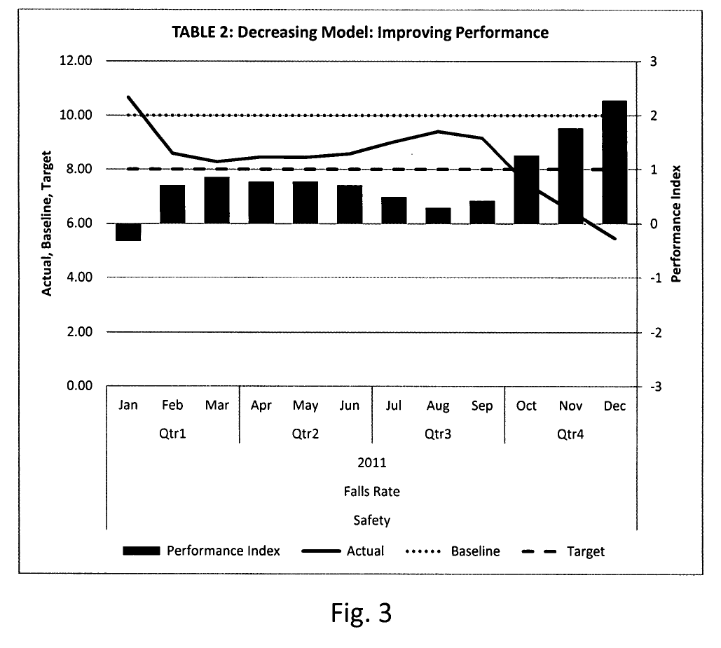

Referring to FIG. 3, Table 2: Decreasing Model: Improving Performance, there is shown a graph which charts the Falls Rate in an institution over time from January to December, 2011.

The left axis represents the Actual, Baseline and Target values.

The Falls Rate is a decreasing model, which means the objective is for the Actual number of falls occurring in the institution to decrease over time.

The Baseline value in a decreasing model is above the Target value.

In this example, the measure started above the Baseline value (poor) and decreased until it is below the Target value (good).

The right axis represents the Performance Index values, with the Performance Index represented by the bars. A Performance Index of 0 or less means that performance is poor. A Performance Index of 1 or more means that performance is good.

At the start of this example, the Performance Index is below 0, which corresponds with the Actual value being worse than the Baseline value.

At the end of this example, the Performance Index is above 1. This corresponds with the Actual value being better than the Target value.

TABLE 2

| | Actual | Baseline | Target | Performance Index |
|---|---|---|---|---|
| Safety | 8.34 | 10.00 | 8.00 | 0.83 |
| Falls Rate | 8.34 | 10.00 | 8.00 | 0.83 |
| 2011 | | | | |
| Qtr1 | | | | |
| January | 10.66 | 10.00 | 8.00 | −0.33 |
| February | 8.60 | 10.00 | 8.00 | 0.70 |
| March | 8.29 | 10.00 | 8.00 | 0.86 |
| Qtr2 | | | | |
| April | 8.46 | 10.00 | 8.00 | 0.77 |
| May | 8.45 | 10.00 | 8.00 | 0.77 |
| June | 8.58 | 10.00 | 8.00 | 0.71 |
| Qtr3 | | | | |
| July | 9.03 | 10.00 | 8.00 | 0.49 |
| August | 9.42 | 10.00 | 8.00 | 0.29 |
| September | 9.16 | 10.00 | 8.00 | 0.42 |
| Qtr4 | | | | |
| October | 7.47 | 10.00 | 8.00 | 1.26 |
| November | 6.47 | 10.00 | 8.00 | 1.77 |
| December | 5.45 | 10.00 | 8.00 | 2.28 |

### Table 3: Corridor Model: Improving Performance

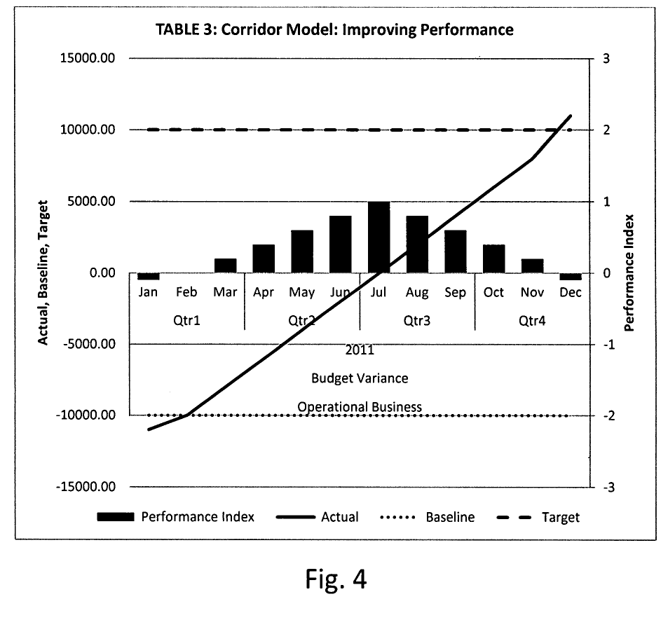

Referring to FIG. 4, Table 3: Corridor Model: Improving Performance, there is shown a graph which charts the Budget Variance in an institution over time from January to December, 2011.

The left axis represents the Actual, Baseline and Target values.

The Budget Variance is a corridor model, which means the objective is for the Actual number to remain close to a midpoint.

The Baseline value in a corridor model is below the Target value. Together, the Baseline and Target form an acceptable range.

In this example, the Actual value started below the Baseline value (poor) and increased until it is now above the Target value (poor). The best performance is seen in July where the variance is $0.

Performance is good when the values are close to the midpoint. The best performance is seen in July where the Performance Index=1.

The right axis represents the Performance Index values, with the Performance Index represented by the bars. A Performance Index of 0 or less means that performance is poor. A Performance Index of 1 or more means that performance is good.

At the start of this example, the Performance Index is below 0, which corresponds with the Actual value being worse than the Baseline value and therefore outside the corridor.

At the end of this example, the Performance Index is below 0. This corresponds with the Actual value being beyond the Target value and therefore outside the corridor.

TABLE 3

| | | | | Performance |
|---|---|---|---|---|
| | Actual | Baseline | Target | Index |
| Operational Business | −833.33 | −10000.00 | 10000.00 | 0.40 |
| Budget Variance | −833.33 | −10000.00 | 10000.00 | 0.40 |
| 2011 | | | | |
| Qtr1 | | | | |
| January | −11000.00 | −10000.00 | 10000.00 | −0.10 |
| February | −10000.00 | −10000.00 | 10000.00 | 0.00 |
| March | −8000.00 | −10000.00 | 10000.00 | 0.20 |
| Qtr2 | | | | |
| April | −6000.00 | −10000.00 | 10000.00 | 0.40 |
| May | −4000.00 | −10000.00 | 10000.00 | 0.60 |
| June | −2000.00 | −10000.00 | 10000.00 | 0.80 |
| Qtr3 | | | | |
| July | 0.00 | −10000.00 | 10000.00 | 1.00 |
| August | 2000.00 | −10000.00 | 10000.00 | 0.80 |
| September | 4000.00 | −10000.00 | 10000.00 | 0.60 |
| Qtr4 | | | | |
| October | 6000.00 | −10000.00 | 10000.00 | 0.40 |
| November | 8000.00 | −10000.00 | 10000.00 | 0.20 |
| December | 11000.00 | −10000.00 | 10000.00 | −0.10 |

### Application of Stratim™ Performance Index Normalization (SPIN)

This technique is normally applied to measuring organizational performance. It can also be used to measure individual performance.
How well is a staff member performing relative to his peers?
How well is his department doing relative to others?
How well is the overall organization doing?

These insights accrue automatically due to the performance index normalization model. The results can be aggregated and disaggregated easily.

A further example might be the application to individual and community health. Imagine an older person in a long term care facility getting the result of their check up.

Doctor: “Your blood pressure is 180 over 110. Your LDL cholesterol is 130. Your HDL cholesterol is 30. Your BMI is 27.”

Patient at 85: “I do not understand, Doctor. Is it good or bad?”

Without SPIN, it is very difficult to know if things are getting better or worse. With SPIN, the patient and family could get a green-yellow-red light symbol to tell them if things are good or bad on each measure as well as an overall rating score. Some of these indicators are good when going up. Others are good when going down. Normalization will translate the SPIN into a “good is up” rate. This is like getting a percentage mark in each subject and an overall average. People will get it.

This could revolutionize how healthcare information is reported.

At the community level, the data from random sampling or complete hospital records could give an overall community health score. This will be critical to managing health care outcomes.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A method for evaluating individual and organizational performance using a computer to determine the Performance Index value using the following formulae:
Performance Index value=Numerator (Num) divided by Denominator (Den),
where Num=IF(Model=“Increasing”,Actual−Baseline,IF(Model=“Decreasing”,Baseline−Actual,IF(Model=“Corridor”,(Mid−Baseline)−ABS(Mid−Actual),0))) where Mid=(Target+Baseline)/2; and
Den=IF(Model=“Increasing”,Target−Baseline,IF(Model=“Decreasing”,Baseline−Target,IF(Model=“Corridor”,(Mid−Baseline),0))) where Mid=(Target+Baseline)/2.

2. The method for evaluating individual and organizational performance using a computer according to claim 1, wherein the objective is to have increasing actual values over time, further comprising the steps of:
(a) calculating the numerator, where the numerator is the Actual value minus the Baseline value;
(b) calculating the denominator, where the denominator is the Target value minus the Baseline value; and
(c) calculating the Performance Index value by dividing the numerator by the denominator.

3. The method for evaluating individual and organizational performance using a computer according to claim 1, wherein objective is to have decreasing actual values over time, further comprising the steps of:
(a) calculating the numerator, where the numerator is the Baseline value minus the Actual value;
(b) calculating the denominator, where the denominator is the Baseline value minus the Target value; and
(c) calculating the Performance Index value by dividing the numerator by the denominator.

4. The method for evaluating individual and organizational performance using a computer according to claim 1, wherein the objective is to have relatively consistent actual values over time, further comprising the steps of:
(a) calculating the numerator, where the numerator is (Mid value minus Baseline value) minus the absolute value of (Mid value minus Actual value), and where the Mid value is the sum of the Target value and the Baseline value, divided by 2;
(b) calculating the denominator, where the denominator is the Mid value minus Baseline value, where the Mid value is the sum of the Target value and the Baseline value, divided by 2; and
(c) calculating the Performance Index value by dividing the numerator by the denominator.

5. The method for evaluating individual and organizational performance using a computer according to claim 1, further comprising wherein the attribute information comprises skills information, geographic location information, language information, availability information, or any combination thereof, for one or more human resources.

6. The method for evaluating individual and organizational performance using a computer according to claim 2, further comprising wherein the attribute information comprises skills information, geographic location information, language information, availability information, or any combination thereof, for one or more human resources.

7. The method for evaluating individual and organizational performance using a computer according to claim 3, further comprising wherein the attribute information comprises skills information, geographic location information, language information, availability information, or any combination thereof, for one or more human resources.

8. The method for evaluating individual and organizational performance using a computer according to claim 4, further comprising wherein the attribute information comprises skills information, geographic location information, language information, availability information, or any combination thereof, for one or more human resources.

9. A method for evaluating individual and organizational raw performance using a computer to determine a Stratim™ Performance Index Normalization (SPIN) value using the following formulae:
Performance=Numerator (Num) divided by Denominator (Den),
where Num=IF(Model=“Increasing”,Actual−Baseline,IF(Model=“Decreasing”,Baseline−Actual,IF(Model=“Corridor”,(Mid−Baseline)−ABS(Mid−Actual),0))) . . . where Mid=(Target+Baseline)/2;
Den=IF(Model=“Increasing”,Target−Baseline,IF(Model=“Decreasing”,Baseline−Target,IF(Model=“Corridor”,(Mid−Baseline),0))) . . . where Mid=(Target+Baseline)/2;
If Function=1 (Raw Performance is chosen), SPIN=Performance; and
If Function=0 (Standardized Performance is chosen), SPIN=IF(Performance>1,1,IF(Performance<0,0,Performance)).

10. The method for evaluating individual and organizational raw performance using a computer according to claim 9, wherein the objective is to have increasing actual values over time, further comprising the steps of:
(a) calculating a numerator, where the numerator is an Actual value minus a Baseline value;
(b) calculating a denominator, where the denominator is a Target value minus the Baseline value; and
(c) calculating a Performance value by dividing the numerator by the denominator, verifying a value of 1 is assigned to a Function parameter, then assigning the Performance value to a Stratim™ Performance Index Normalization value.

11. The method for evaluating individual and organizational raw performance using a computer according to claim 9, wherein objective is to have decreasing actual values over time, further comprising the steps of:
(a) calculating a numerator, where the numerator is an Actual value minus a Baseline value;
(b) calculating a denominator, where the denominator is a Target value minus the Baseline value; and
(c) calculating a Performance value by dividing the numerator by the denominator, verifying a value of 1 is assigned to a Function parameter, then assigning the Performance value to a Stratim™ Performance Index Normalization value.

12. The method for evaluating individual and organizational raw performance using a computer according to claim 9, wherein the objective is to have relatively consistent actual values over time, further comprising the steps of:
(a) calculating a numerator, where the numerator is an Actual value minus a Baseline value;
(b) calculating a denominator, where the denominator is a Target value minus the Baseline value; and
(c) calculating a Performance value by dividing the numerator by the denominator, verifying a value of 1 is assigned to a Function parameter, then assigning the Performance value to a Stratim™ Performance Index Normalization value.

13. A method for evaluating individual and organizational standardized performance using a computer, wherein the objective is to have increasing actual values over time, comprising the steps of:
(a) calculating a numerator, where the numerator is an Actual value minus a Baseline value;
(b) calculating a denominator, where the denominator is a Target value minus the Baseline value;
(c) calculating a performance value by dividing the numerator by the denominator, assigning a value of 0 to a function value, and
(i) assigning the performance value to a Stratim™ Performance Index Normalization value if the Performance value is greater than 0 and less than 1;
(ii) assigning the Stratim™ Performance Index Normalization value to 0 if the Performance value is less than or equal to 0; and
(iii) assigning the Stratim™ Performance Index Normalization value to 1 if the Performance value is greater than or equal to 1.

14. A method for evaluating individual and organizational standardized performance using a computer, wherein objective is to have decreasing actual values over time, comprising the steps of:
(a) calculating a numerator, where the numerator is an Actual value minus a Baseline value;
(b) calculating a denominator, where the denominator is a Target value minus the Baseline value;
(c) calculating a performance value by dividing the numerator by the denominator, assigning a value of 0 to a function value, and
(i) assigning the Performance value to a Stratim™ Performance Index Normalization value if the Performance value is greater than 0 and less than 1;
(ii) assigning the Stratim™ Performance Index Normalization value to 0 if the Performance value is less than or equal to 0; and
(iii) assigning the Stratim™ Performance Index Normalization value to 1 if the Performance value is greater than or equal to 1.

15. The method for evaluating individual and organizational raw performance using a computer according to claim 9, further comprising wherein the attribute information comprises skills information, geographic location information, language information, availability information, or any combination thereof, for one or more human resources.

16. The method for evaluating individual and organizational raw performance using a computer according to claim 10, further comprising wherein the attribute information comprises skills information, geographic location information, language information, availability information, or any combination thereof, for one or more human resources.

17. The method for evaluating individual and organizational raw performance using a computer according to claim 11, further comprising wherein the attribute information comprises skills information, geographic location information, language information, availability information, or any combination thereof, for one or more human resources.

18. The method for evaluating individual and organizational raw performance using a computer according to claim 12, further comprising wherein the attribute information comprises skills information, geographic location information, language information, availability information, or any combination thereof, for one or more human resources.

19. The method for evaluating individual and organizational standardized performance using a computer according to claim 13, further comprising wherein the attribute information comprises skills information, geographic location information, language information, availability information, or any combination thereof, for one or more human resources.

20. The method for evaluating individual and organizational standardized performance using a computer according to claim 14, further comprising wherein the attribute information comprises skills information, geographic location information, language information, availability information, or any combination thereof, for one or more human resources.
